(19) United States
(12) Patent Application Publication
(10) Pub. No.: US 2013/0046894 A1
(43) Pub. Date: Feb. 21, 2013

(54) MODEL-DRIVEN REST CONSUMPTION FRAMEWORK

(71) Applicants: Bare Said, St. Leon-Rot (DE); Stefan Baeuerle, Rauenberg-Rotenberg (DE); Klaus Herter, Leimen (DE); Lars Erbe, Stutensee (DE)

(72) Inventors: Bare Said, St. Leon-Rot (DE); Stefan Baeuerle, Rauenberg-Rotenberg (DE); Klaus Herter, Leimen (DE); Lars Erbe, Stutensee (DE)

(73) Assignee: SAP AG, Walldorf (DE)

(21) Appl. No.: 13/212,641

(22) Filed: Aug. 18, 2011

(51) Int. Cl. G06F 15/173

(52) U.S. Cl. 709/226

(57) ABSTRACT

The present disclosure describes methods, systems, and computer program products for implementing web services. One method includes identifying a REST service for integration with a business application, identifying a set of metadata associated with the REST service, and generating a REST client proxy object associated with the REST service for use in consuming the REST service with the business application, where an instantiation of the REST client proxy object is consumable via the business application. In some instances, the method may include consuming the REST service using an instantiation of the generated REST client proxy object associated with the REST service. Further, the identified set of metadata associated with the REST service may include a service structure document and a metadata document. Generating the REST client proxy object may include generating at least one business configuration object and/or at least one authentication proxy artifact associated with the REST service.

### TECHNICAL FIELD

The present disclosure relates to software, computer systems, and computer-implemented methods for implementing web services.

### BACKGROUND

A business object is a software code construct that corresponds directly to a thing in the actual business the software is meant to represent. The business object can encapsulate the business logic related to the thing, and can encapsulate the data that is required by the logic and also describes, defines, makes up, is contained by, and/or is associated with the thing. The business objects and their components may generally be recognizable to a non-technical entity, such as the software's users, business analysts, and the like. Each business object can include data that describes or is attributed to the object and methods that make decisions based on that data. Business objects can be associated with real-world items and concepts; however, some business objects are more conceptual in nature, but still have a real-world counterpart.

Web services are methods of communication between two electronic devices over a network. Specifically, a web service may be described as a software system designed to support interoperable machine-to-machine interaction over a network. A web service can have an interface described in machine-processable format, such as Web Services Description Language (WSDL). Systems can interact with a web service in a manner prescribed by its description, for instance, using SOAP messages. Two major classes of web services generally exist: REST-compliant web services, in which the primary purpose of the service is to manipulate XML representations of web resources using a uniform set of “stateless” operations, and arbitrary web services, in which the service may expose an arbitrary set of operations. REST-based web services do not require XML, SOAP, or WSDL service-API definitions. Instead, REST-based web services can constrain their interfaces to a small set of well-known, standard operations (i.e., GET, POST, PUT, and DELETE for use with HTTP interactions). REST-based web services interact with stateful resources as opposed to stateful messages and operations.

### SUMMARY

The present disclosure describes methods, systems, and computer program products for implementing web services. One method includes identifying a REST service for integration with a business application, identifying a set of metadata associated with the REST service, and generating a REST client proxy object associated with the REST service for use in consuming the REST service with the business application, where an instantiation of the REST client proxy object is consumable via the business application. In some instances, the method may include consuming the REST service using an instantiation of the generated REST client proxy object associated with the REST service. Further, the identified set of metadata associated with the REST service may include a service structure document and a metadata document. Generating the REST client proxy object may include generating at least one business configuration object and/or at least one authentication proxy artifact associated with the REST service.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for implementing various features of a system providing a REST consumption framework for allowing applications to consistently access REST-based web services.

FIG. 2 is an illustration of an example of communication between REST client proxies (RCPs) of a REST consumption framework for interacting with at least one external REST service provider.

FIG. 3 is a more detailed illustration of example communication between an RCP and one or more external REST service providers.

FIG. 4 is an illustration of a process for analyzing a particular REST service and generating an associated RCP for consuming the particular REST service.

FIG. 5 is a flowchart of an example process for generating a RCP associated with a particular external REST service.

FIG. 6 is a flowchart of an example process for integrating a particular RCP into a business application.

FIG. 7 is a flowchart of an example process for using a particular RCP in a business application to consume the external REST service corresponding to the particular RCP.

### DETAILED DESCRIPTION

This disclosure generally relates to software, computer systems, and computer-implemented methods for implementing web services. Specifically, tools and methods are used to analyze the structure and requirements of a particular web service and to generate an executable object or proxy corresponding to the particular web service that can be used or instantiated within a business application and that can be used to consume the particular web service without requiring a developer or user inserted call to the particular web service. In one example, the web service or services can be REST-based services. To perform the operations in a particular implementation, a REST consumption framework (RCF) is provided to a system to allow REST services to be integrated into one or more business applications. In some instances, the one or more business applications can use REST client proxies (RCPs) created by the RCF to identify and consume particular external REST services in a manner similar to the use or consumption of other objects within the business application. In other words, the REST service can be consumed by a particular application without requiring user-specific knowledge of the external REST service, instead allowing for a typical object interaction to be used.

The RCF may allow for business objects corresponding to the external REST service to be generated, with those business objects, or proxies, capable of being consumed by a business application and used to transparently access the external REST service. The RCF can also provide a business configuration entity (BCO) that allows the business application to request and consume specific and consistent configurations of the corresponding REST service. For example, different types of requests and/or locations (i.e., URLs) associated with the external REST service can be accessed using different options of the BCO, as well as different types of authentication methods and types. Further, the RCF can handle the adoption of different types of authentication models for REST consumption scenarios that are typically based on end user service requests. For example, specific passwords, credentials, and other information may be interpreted and used by the RCF to access and interact with the external REST service, as necessary.

In general, the RCF is model-driven and allows business applications (or other software as appropriate) to access one or more external REST services. An outside-in approach to accessing the REST services is achieved based on the generation of a business object, or RCP, that is itself based on the structure and requirements of the external REST service and REST service provider requirements. REST services may be documents with service and metadata documents to describe the structure of exposed resources and data structures, such as Microsoft's OData-based REST services. Using these documents, the RCF can generate a corresponding business object to act as a proxy entity (RCP) for interacting with and consuming the REST service. An approach using a business object-related proxy allows for integration into business object-based systems and architectures. In some instances, a generated interface, as opposed to an entire business object or RCP, may be sufficient for integration into the corresponding programming model. Additionally, an appropriate BCO may be created along with the RCP to offer configuration possibilities after deployment, such as different but related URLs associated with the external REST service, as well as different parameters that are to be included in a particular URL used to call the REST service. The correct or selected URL can be propagated to the calling component, agent, or other entity at runtime. Still further, the RCF can also generate appropriate artifacts to satisfy authentication aspects of the REST service. In general, the introduction of the RCF allows the encapsulation of REST API consumption provided by different REST service providers.

The RCF and its generated RCPs can be used to add stand-alone UI consumption of REST services to a business application, as well as integration of REST content and operations into existing application UIs, such as REST service-related content provided by social network providers. Analytics-based REST service content can be integrated into one or more existing applications as well. Further, REST content can be seamlessly integrated and harmonized into a particular business application with information, content, and operations provided by external partners, developers, and other third parties. In fact, the use of REST content may be essentially hidden from users, as the harmonization of the RCP with the business application infrastructure and architecture can allow for seamless integration of the REST service, such as by hiding the API consumer implementation. In some instances, the user working in a specific UI may recognized the underlying data source or information from the data source, such as when a social web-related REST service is used. Further, the RCF can manage REST service consumption based on a harmonized architectural approach provided by the associated business process application and development environment. By integrating a business object generated by the RCF into a particular business application, the particular business application can apply its own consistent lifecycle management, monitoring, testing, and supportability for the proxy without needed new or different rules or information for the particular RCP.

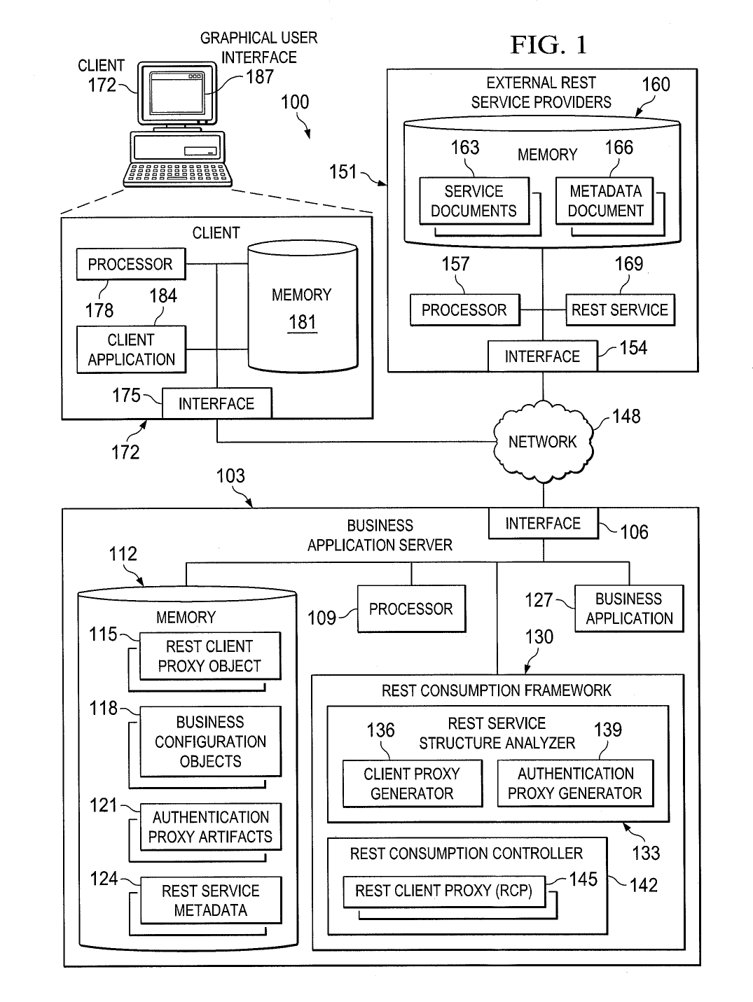

FIG. 1 illustrates an example environment 100 for implementing various features of a system providing a REST consumption framework that allows for consistent access and consumption of REST-based services. The illustrated environment 100 includes, or is communicably coupled with, a business application server 103, at least one external REST service provider 151, and at least one client 172. At least some of the communications between the business application server 103, the external REST service provider(s) 151, and the clients 172 may be performed across or via network 148. In general, environment 100 depicts an example configuration of a system for accessing metadata and definitions associated with at least one REST service provided by one or more REST service providers, generating at least one REST client proxy (RCP) to be used for consuming the corresponding REST service, and integrating those RCPs into one or more business applications 127. As illustrated, the business application 127 may be executed as a hosted solution stored at the business application server 103. One or more clients 172 may access the business application server 103 through network 148 to request or cause operations of the business application 127 to be performed, where the business application 127 may consume the corresponding REST service during its execution using the corresponding RCP. The environment 100 is an example, and in alternative implementations, the elements illustrated in FIG. 1 may be included in or associated with different and/or additional servers, clients, networks, and locations other than those as shown. For example, one or more of the components illustrated within the business application server 103 may be located in multiple or different servers, cloud-based networks, or other locations accessible to the business application server 103 (e.g., either directly or indirectly via network 148).

In general, the business application server 103 is any server that stores and executes one or more business applications 127. For example, each business application server 103 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, each business application server 103 may store a plurality of various other applications, while in other instances, each business application server 103 may be a dedicated server meant to store and execute a particular business application 127 and its related functionality. In some instances, the business application server 103 may comprise a web server or be communicably coupled with a web server, where one or more of the business applications 127 associated with the business application server 103 represent web-based (or web-accessible) applications accessed and executed through requests and interactions received on the client 172, executing a client application 184 operable to interact with the programmed tasks or operations of the corresponding business application 127.

At a high level, the business application server 103 comprises an electronic computing device operable to receive, transmit, process, store, or manage data and information associated with the environment 100. The business application server 103 illustrated in FIG. 1 can be responsible for receiving application requests from one or more clients 172 (as well as any other entity or system interacting with the business application server 103, including desktop or mobile client systems), responding to the received requests by processing said requests in the associated business application 127, and sending the appropriate responses from the business application 127 back to the requesting client 172 or other requesting system. The business application 127 can also process and respond to local requests from a user locally accessing the business application server 103. Accordingly, in addition to requests from the clients 172 illustrated in FIG. 1, requests associated with a particular business application 127 may also be sent from internal users, external or third-party customers, and other associated business applications or business processes, as well as any other appropriate entities, individuals, systems, or computers. In some instances, the business application 127 may be a web-based application executing functionality associated with a networked or cloud-based business process.

As used in the present disclosure, the term “computer” is intended to encompass any suitable processing device. For example, although FIG. 1 illustrates a single business application server 103, environment 100 can be implemented using any number of servers, as well as computers other than servers, including a server pool. Indeed, the business application server 103 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the illustrated business application server 103 may be adapted to execute any operating system, including Linux, UNIX, Windows, Mac OS, or any other suitable operating system.

In the illustrated implementation of FIG. 1, the business application server 103 includes an interface 106, a processor 109, a memory 112, a business application 127, and a REST consumption framework (RCF) 130. In some instances, the business application server 103 and its illustrated components may be separated into multiple components executing at different servers and/or systems. For example, while FIG. 1 illustrates the business application 127 and the RCF 130 as separate components, other example implementations can include the RCF 130 as a component of the business application 127, as well as part of the business application's inherent functionality. Thus, while illustrated as a single component in the example environment 100 of FIG. 1, alternative implementations may illustrate the business application server 103 as comprising multiple parts or portions accordingly.

FIG. 1 depicts a server-client environment, but could also represent a cloud computing network. Various other implementations of the illustrated environment 100 can be provided to allow for increased flexibility in the underlying system, including multiple business application servers 103 performing or executing one or more additional or alternative instances of the business application 127, as well as other applications associated with or related to the business application 127, including those illustrated as included as part of the business application 127. In those instances, the different business application servers 103 may communicate with each other via a cloud-based network or through the connections provided by network 148.

The interface 106 is used by the business application server 103 to communicate with other systems in a client-server or other distributed environment (including within environment 100) connected to the network 148 (e.g., one of the clients 172, as well as other systems communicably coupled to the network 148). The interface 106 generally comprises logic encoded in software and/or hardware in a suitable combination and operable to communicate with the network 148. More specifically, the interface 106 may comprise software supporting one or more communication protocols associated with communications such that the network 148 or the interface's hardware is operable to communicate physical signals within and outside of the illustrated environment 100.

Generally, the business application server 103 may be communicably coupled with a network 148 that facilitates wireless or wireline communications between the components of the environment 100 (i.e., between the business application server 103 and one or more clients 172), as well as with any other local or remote computer, such as additional clients, servers, or other devices communicably coupled to network 148, including those not illustrated in FIG. 1. In the illustrated environment, the network 148 is depicted as a single network, but may be comprised of more than one network without departing from the scope of this disclosure, so long as at least a portion of the network 148 may facilitate communications between senders and recipients. In some instances, one or more of the components associated with the business application server 103 may be included within the network 148 as one or more cloud-based services or operations.

The network 148 may be all or a portion of an enterprise or secured network, while in another instance, at least a portion of the network 148 may represent a connection to the Internet. In the illustrated example, at least a portion of the network 148 includes a portion of a cellular or mobile data network or other network capable of relaying SMS messages. In some instances, a portion of the network 148 may be a virtual private network (VPN). Further, all or a portion of the network 148 can comprise either a wireline or wireless link. Example wireless links may include 802.11a/b/g/n, 802.20, WiMax, and/or any other appropriate wireless link. In other words, the network 148 encompasses any internal or external network, networks, sub-network, or combination thereof operable to facilitate communications between various computing components inside and outside the illustrated environment 100. The network 148 may communicate, for example, Internet Protocol (IP) packets, Frame Relay frames, Asynchronous Transfer Mode (ATM) cells, voice, video, data, and other suitable information between network addresses. The network 148 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the business application server 103 includes a processor 109. Although illustrated as a single processor 109 in the business application server 103, two or more processors may be used in the business application server 103 according to particular needs, desires, or particular embodiments of environment 100. The processor 109 may be a central processing unit (CPU), a blade, an application specific integrated circuit (ASIC), a field-programmable gate array (FPGA), or another suitable component. Generally, the processor 109 executes instructions and manipulates data to perform the operations of the business application server 103 and, specifically, the functionality associated with the corresponding business application 127 and the RCF 130. In one implementation, the server's processor 109 executes the functionality required to receive and respond to requests and instructions from the client 172, as well as the functionality required to perform the operations of the associated business application 127 and the RCF 130, among others.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated environment 100, each processor 109 executes the corresponding business application 127 stored on the associated business application server 103. In some instances, a particular business application server 103 may be associated with the execution of two or more business applications 127 (and other related components), as well as one or more distributed applications executing across two or more business application servers 103.

At a high level, each business application 127 is any application, program, module, process, or other software that may execute, change, delete, generate, or otherwise manage information associated with a particular business application server 103, and in some cases, a business process performing and executing business process-related events. In particular, business processes communicate with other users, applications, systems, and components to send, receive, and process events. In some instances, a particular business application 127 may operate in response to and in connection with one or more requests received from an associated client 172 or other remote client. Additionally, a particular business application 127 may operate in response to and in connection with one or more requests received from other business applications 127, including a business application associated with another business application server 103. In some instances, the business application 127 may request additional processing or information from an external system or application, such as a web, or REST, service. In some instances, each business application 127 may represent a web-based application accessed and executed by remote clients 172 via the network 148 (e.g., through the Internet, or via one or more cloud-based services associated with the business application 127). Further, while illustrated as internal to the business application server 103, one or more processes associated with a particular business application 127 may be stored, referenced, or executed remotely. For example, a portion of a particular business application 127 may be a web service that is remotely called, while another portion of the business application 127 may be an interface object or agent bundled for processing at a remote system (not illustrated) or client 172 (e.g., the client application 184). Moreover, any or all of a particular business application 127 may be a child or sub-module of another software module or enterprise application (not illustrated) without departing from the scope of this disclosure. Still further, portions of the particular business application 127 may be executed or accessed by a user working directly at the business application server 103, as well as remotely at a corresponding client 172.

Each business application 127 can integrate information from one or more REST services into its operations. In some instances, a particular business application 127 may directly call a URL associated with a particular REST service. In those instances, the business application 127 may need to be designed to access, provide information to, and incorporate information received from the particular REST service via the preexisting operations of the business application 127. Alternatively, using the example tools, methods, and systems described herein, the business application 127 can use an one or more REST client proxies 145 (or instantiations thereof) generated by the RCF 130 to transparently and easily incorporate the functionality of the corresponding REST service into the business application 127. Specifically, the operations of the RCF 130 can be used to do so.

The RCF 130 is used to generate proxies representing one or more external REST services that can be instantiated by or for a corresponding business application 127 to consume the REST service while maintaining the normal operations (i.e., lifecycle management, analytics, monitoring, testing, etc.) of the underlying business application 127. In one instance, the proxies can be represented as business objects similar to those normally used and interacted with by the business application 127 to perform regular operations. Further, RCPs can be used by the business application 127 to access the functionality of one or more REST services without requiring developers to know the explicit details of how the REST service operates, including the particular REST service URL and the type and format of the input and authentication necessary to use the REST service. Instead, the business application 127 can call the RCP (or instantiate an instance of the RCP) corresponding to the REST service, where the RCP defines and includes the details for interacting with and consuming the REST service.

The RCF 130 can identify REST services for which a corresponding RCP is to be generated. In some instances, developers can manually identify a particular REST service to the RCF 130 for which access is needed. Alternatively, the RCF 130 can identify one or more commonly used REST services and determine that corresponding RCPs may be necessary, using that determination to identify one or more REST services for which RCPs are to be generated. In still other instances, one or more Universal Description, Discovery and Integration (UDDI) registries associated with and/or linking to one or more web services may be identified, with at least a portion of the associated web services being identified for generating corresponding RCPs. Changes or modifications to the UDDI registry may trigger an analysis of and/or update to one or more RCPs, as well as the generation of new RCPs. REST APIs also frequently occur with a version in the URI access path. This may mean that there is a compatibility contract where REST APIs must not break the consumption coding unless they introduce a new version that outlines a semantic change, allowing customers and REST service consumers to decide whether to stay with a prior version or to adopt the new version. Changes in the version number may trigger an analysis of and/or update to RCPs, as well as the generation of new RCPs.

In some instances, the RCF 130 can include a plurality of components to perform its operation, while in others the RCF 130 may be a single component. As illustrated in the example implementation of FIG. 1, the example RCF 130 includes two separate components: a REST service structure analyzer 133 and a REST consumption controller 142. The REST service structure analyzer 133 can identify, receive, retrieve, or otherwise be provided access to metadata defining a particular REST service, and use that metadata to generate one or more RCPs associated with the particular REST service. The metadata can be stored in memory 112 as the REST service metadata 124. The REST service structure analyzer 133 may be used at design time to generate the components (i.e., the RCP, one or more business configuration objects (BCOs) 118, one or more authentication proxy artifacts 121, etc.).

The REST service structure analyzer 133 includes a client proxy generator 136 and an authentication proxy generator 139. The service structure analyzer 133, and in part, the client proxy generator 136 retrieve the metadata defining the particular REST service (e.g., the service documents 163 and the metadata document 166) from the external REST service provider 151. The metadata and information associated with these documents may include element names, data types, input constraints and requirements, associations between elements and entities of the REST service, as well as other information. The documents may be provided in formats including Microsoft's OData, Google's GData, as well as other suitable web service descriptions and standards. The metadata information may be located at the external REST service provider server 151, or at any other suitable location accessible via network 148 or by other means.

The client proxy generator 136 takes the metadata information associated with the particular REST service, which may be in the form of XML documents, and can analyze the format and structure of the information. Based on that analysis, the client proxy generator 136 can generate a corresponding RCP 145 that can define an object or interface corresponding to the metadata information and definition associated with the REST service. The RCP 145 may be represented as a new business object, an interface, or other appropriate structure or object, including other transformation elements. Generated RCPs can be stored in a repository of memory 112, illustrated in example FIG. 1 as the set of REST client proxy objects 115. In instances where the REST service can be called or initiated using different configurations, the client proxy generator 136 can generate one or more BCOs 118 (which can also be stored in memory 112, where appropriate). The BCOs 118 can be used when a particular REST service is to be consumed using an RCP 145 by defining the particular configuration or settings in which the REST service is to be called. For example, a REST service may be capable of receiving requests at two different URLs (or the same URL with different input parameters) where the different requests cause a variation in processing and output. By creating the different BCOs 118, the business application 127 can call the appropriate BCO 118 according to the desired REST service operation at runtime. A generated RCP can be made available to and reused by more than one business application (or instance thereof), where appropriate.

The authentication proxy generator 139 can create objects or artifacts that can be used to provide the authentication requirements of a particular REST service. In some instances, certain authentication parameters may be provided by consumers of a REST service when the request is sent. Because the RCP 145 is generally meant to allow for transparent access to the REST service via the business application 127, corresponding authentication proxy artifacts 121 may be created at design time to allow the business application 127 and corresponding RCP 145 to access the REST service. External REST service providers may use different types of authentication techniques, and in some instances, may use different authentication based on the particular variation of the REST service accessed. The authentication proxy generator 139 identifies the appropriate means of authentication defined in the metadata information of the REST service, and can generate artifacts associated with each RCP 145 that can be used at runtime to meet the defined authentication requirements and parameters of the REST service, thereby allowing access to the service's functionality without user interaction. Examples of REST service provider authentication may include OAuth 1.0A (e.g., 3-legged, 2-legged, SAML2.0 assertion for REST API access, and basic authentication, among others). The generated authentication proxy artifacts 121 can be associated with or otherwise linked to the corresponding RCPs 115, 145 used by the RCF 130, such that when a particular RCP 145 is instantiated or used, the associated authentication proxy artifact 121 is retrieved and used by the RCF 130. In some instances, the particular authentication proxy artifact 121 to be used for an RCP 145 may be determined based on the BCO 118 used in or associated with a REST service call.

The REST consumption controller 142 may be associated with and/or perform the runtime functionality of the RCF 130. In some instances, the REST consumption controller 142 is the component used by the RCF 130 to use, work with, and consume the generated RCPs 145 and other artifacts (i.e., BCOs 118 and authentication proxy artifacts 121). Specifically, when the business application 127 wants to access or consume a particular REST service, the corresponding RCP 145 is called and used by the business application 127 to consume the particular REST service. The RCP 145 uses the information received from the business application 127 to generate and provide the request to the external REST service, as well as to receive and interpret the corresponding output and result of the REST service's execution. In some instances, the REST consumption controller 142 may determine the appropriate configuration in which the REST service is to be called and consumed, thereby selecting the appropriate BCO 118 to use with the call. Based on the RCP 145 and/or the selected BCO 118, the corresponding authentication proxy artifact 121 may be selected by the REST consumption controller 142 and used to access the REST service.

The business processes performed by the business application 127 may include actions performed on or associated with one or more business objects stored in memory 112 (not illustrated). The memory 112 of the business application server 103 stores data and program instructions. The memory 112 may include any memory or database module and may take the form of volatile or non-volatile memory including, without limitation, magnetic media, optical media, random access memory (RAM), read-only memory (ROM), removable media, or any other suitable local or remote memory component. The memory 112 may store various objects or data, including classes, frameworks, applications, backup data, business objects, jobs, web pages, web page templates, database tables, process contexts, repositories storing services local to the business application server 103, and any other appropriate information including any parameters, variables, algorithms, instructions, rules, constraints, or references thereto associated with the purposes of the server 103 and its business application 127. In some implementations, including a cloud-based system, some or all of the memory 112 may be stored remote from the business application server 103, and communicably coupled to the business application server 103 for usage. As described above, memory 112 can include one or more business objects used by the business application 127, the set of RCPs 115, the set of BCOs 118, the set of authentication proxy artifacts 121, and the REST service metadata 124. Some or all of the elements illustrated within memory 112 may be stored external to the memory 112.

In general, business objects may be a capsule with an internal hierarchical structure, behavior offered by its operations, and integrity constraints. In general, the overall structure of the business object model ensures the consistency of the interfaces that are derived from the business object model. The derivation helps ensure that the same business-related subject matter or concept can be represented and structured in the same way in various interfaces. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Business objects are generally semantically disjointed, i.e., the same business information is represented once. In some embodiments, the business objects are arranged in an ordering framework such that they can be arranged according to their existence dependency to each other. For example, in a modeling environment, the customizing elements might be arranged on the left side of the business object model, the strategic elements might be arranged in the center of the business object model, and the operative elements might be arranged on the right side of the business object model. Similarly, the business objects can be arranged in this model from the top to the bottom based on defined order of the business areas, e.g., finance could be arranged at the top of the business object model with customer relationship management (CRM) below finance and supplier relationship management (SRM) below CRM. To help ensure the consistency of interfaces, the business object model may be built using standardized data types as well as packages to group related elements together, and package templates and entity templates to specify the arrangement of packages and entities within the structure.

A business object may be defined such that it contains multiple layers. Typical business object may contains four layers: a kernel layer, an integrity layer, an interface layer, and an access layer. The innermost layer of the example business object is the kernel layer. The kernel layer represents the business object's inherent data, containing various attributes of the defined business object. The second layer represents the integrity layer. The integrity layer contains the business logic of the object. Such logic may include business rules for consistent embedding in a computing environment and the constraints regarding the values and domains that apply to the business object. Business logic may comprise statements that define or constrain some aspect of the business, such that they are intended to assert business structure or to control or influence the behavior of the business entity. It may pertain to the facts recorded on data and constraints on changes to that data. In effect, business logic may determine what data may, or may not, be recorded in business object. The third layer, the interface layer, may supply the valid options for accessing the business object and describe the implementation, structure, and interface of the business object to the outside world. To do so, the interface layer may contain methods, input event controls, and output events. The fourth and outermost layer of the business object is the access layer. The access layer defines the technologies that may be used for external access to the business object's data. Some examples of allowed technologies may include COM/DCOM (Component Object Model/Distributed Component Object Model), CORBA (Common Object Request Broker Architecture), RFC (Remote Function Call), Hypertext Transfer Protocol (HTTP) and Java, among others. Additionally, business objects of this embodiment may implement standard object-oriented technologies such as encapsulation, inheritance, and/or polymorphism.

As shown in FIG. 1, the illustrated environment 100 includes one or more external service providers 151, each providing one or more REST services 159. Generally, each external REST service provider 151 corresponds to a URL, URI, or other web-addressable location at which other systems can send a request for the performance of the corresponding REST service 159, as well as information to be processed with the REST service's execution. Each external REST service provider 151 can be associated with a single server, computer, or other system, as well as multiple servers and/or systems. As illustrated, each external REST provider system 151 includes an interface 154, a processor 157, and a memory 160. These can be similar to the corresponding components of the business application server 103.

As illustrated, memory 160 can store the metadata information associated with the REST server 169, the metadata information including service documents 163 and metadata documents 166, among other suitable types of metadata. In general, the metadata information can define the type and format of input needed by the corresponding REST service 169, the type and format of the output returned by the REST service 169, the types of operations that can be performed by the REST service 169, instructions on how the REST service 169 should be called and/or addressed, and the type and format of authentication protocols and requirements of the REST service provider, as well as other information relevant to consuming the REST service 169.

The REST service 169 itself can be an application, agent, process, or other software or program that accepts input in a defined manner and returns corresponding output (where appropriate). The REST service 169 generally receives requests from other systems, users, or applications via network 148 and its interface 154. Upon performing its operations, the REST service 169 can return a corresponding set of data to the requesting application in a responsive message (for example, using XML or JavaScript Object Notation) or other suitable communication, again via interface 154 and network 148.

The illustrated environment 100 of FIG. 1 also includes one or more clients 172. The clients 172 may be associated with a particular business application server 103 or business application 127. Each client 172 may be any computing device operable to connect to or communicate with at least one of the business application servers 103 using a wireline or wireless connection via the network 148, or another suitable communication means or channel. In some instances, the client 172 may be a part of or associated with a business process involving one or more of the business applications 124. In general, each client 172 includes a processor 178, an interface 175, a client application 184, a graphical user interface (GUI) 187, and a memory 181. In general, the client 172 comprises an electronic computer device operable to receive, transmit, process, and store any appropriate data associated with the environment 100 of FIG. 1. It will be understood that there may be any number of clients 172 associated with, or external to, environment 100. For example, while illustrated environment 100 includes a single client 172, alternative implementations of environment 100 may include multiple clients communicably coupled to the one or more of the systems illustrated. In some instances, one or more clients 172 may be associated with administrators of the environment, and may be capable of accessing and interacting with the settings and operations of the business application 127, the RCF 130, and/or other components of the business application server 103. Additionally, there may also be one or more additional clients 172 external to the illustrated portion of environment 100 capable of interacting with the environment 100 via the network 148. Further, the terms “client” and “user” may be used interchangeably as appropriate without departing from the scope of this disclosure. Moreover, while each client 172 is described in terms of being used by a single user, this disclosure contemplates that many users may use one computer, or that one user may use multiple computers.

The GUI 187 associated with each client 172 may comprise a graphical user interface operable to, for example, allow the user of a client 172 to interface with at least a portion of the business application 127 and its associated operations and functionality. Generally, the GUI 187 provides the particular user with an efficient and user-friendly presentation of business data provided by or communicated within the system. The GUI 187 may comprise a plurality of customizable frames or views having interactive fields, pull-down lists, and buttons operated by the user. For example, the GUI 187 may provide interactive elements that allow a user to interact with a particular business application 127 or the RCF 130, as well as other components within and/or external to environment 100. The different portions of the business application server's functionality may be presented and accessible to the user through the GUI 187, such as through a client application 184 (e.g., a web browser). Generally, the GUI 187 may also provide general interactive elements that allow a user to access and utilize various services and functions of a particular business application 127. In some instances, the client application 184 may be used to access various portions of different business application servers 103 or business applications 127. In some instances, the client application 184 may be an agent or client-side version of the business application 127. The GUI 187 may present the information of the client application 184 for viewing and interaction. In general, the GUI 187 is often configurable, supports a combination of tables and graphs (bar, line, pie, status dials, etc.), and is able to build real-time portals, where tabs are delineated by key characteristics (e.g., site or micro-site). Therefore, the GUI 187 contemplates any suitable graphical user interface, such as a combination of a generic web browser, intelligent engine, and command line interface (CLI) that processes information in the platform and efficiently presents the results to the user visually.

As used in this disclosure, each client 172 is intended to encompass a personal computer, touch screen terminal, workstation, network computer, kiosk, wireless data port, smart phone, personal data assistant (PDA), one or more processors within these or other devices, or any other suitable processing device. For example, each client 172 may comprise a computer that includes an input device, such as a keypad, touch screen, mouse, or other device that can accept user information, and an output device that conveys information associated with the operation of one or more business application servers 103, those system's business applications 127 and/or RCF 130, and/or the client 172 itself, including digital data, visual information, or the GUI. Both the input and output device may include fixed or removable storage media such as a magnetic storage media, CD-ROM, or other suitable media, to both receive input from and provide output to users of client 172 through the display, namely, the GUI 187. The client's processor 178, interface 175, and memory 181 may be similar to or different from those described in connection with the other components illustrated in FIG. 1, although alternative implementations of one or more of these components may be used, as well as implementations where additional components may also be included.

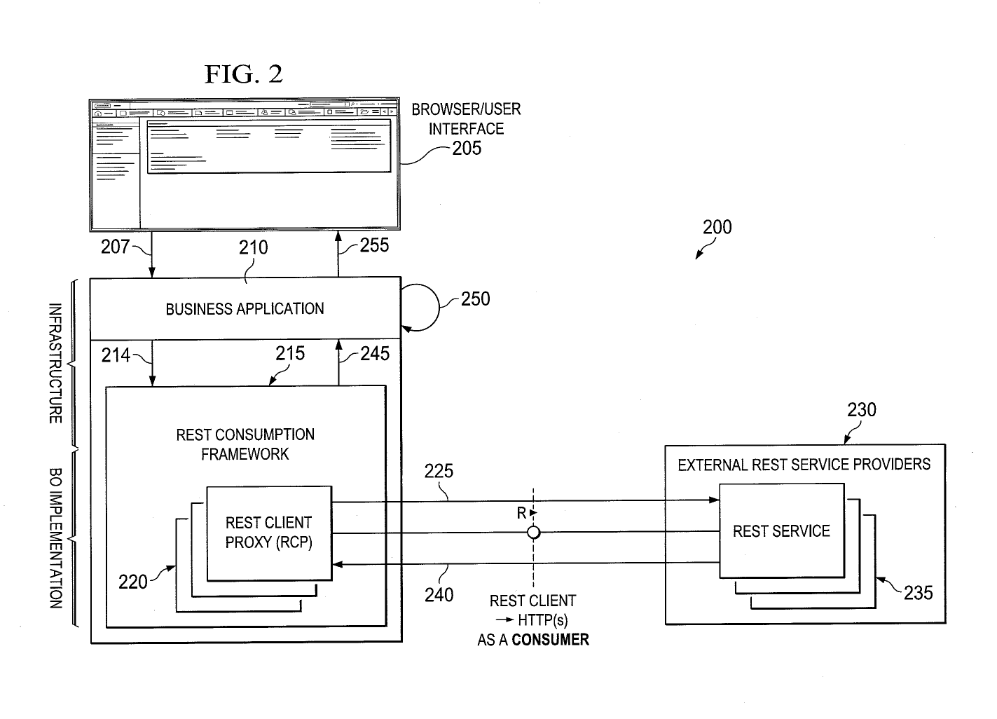

FIG. 2 is an illustration of an example of communication between REST client proxies (RCPs) of a REST consumption framework for interacting with at least one external REST service providers at runtime. As illustrated in FIG. 2, the RCF 215 is included within the business application 210, although other example implementations may include the RCF 215 as separate from the business application 210, as well as a part of the business application's inherent functionality. Specifically, a client is illustrated using a particular browser or UI 205 to access information associated with a particular business application 210. The business application 210 includes at least one call to a REST service 235, and uses the RCF 215 to handle the call. In general, the business application 210 itself is not involved in the actual call to the REST service 235, allowing the RCF 215 to handle the communication requirements associated with REST service 235, and allowing the business application 210 to operate normally without requiring modifications to its operations in order to handle the REST service 235. As illustrated by the arrow 207, at some point the client's interaction with the browser or UI 205 creates a request for functionality associated with a REST service 235. The request is sent to the business application 210. The business application 210 recognizes that a call to a particular REST service 235 is required, and sends a request to the RCF 215 to assist in the consumption of the particular REST service 235 through at least one RCP. The RCF 215 identifies the appropriate generated RCP 220 to be called, and, as illustrated by the arrow 225, makes an appropriate call to the external REST service provider system 230 corresponding to the REST service 235 associated with the business application 210. The call to the REST service 235 (arrow 225) includes information associated with the input to the REST service 235 and the request of the business application 210. After processing, the REST service 235 returns a set of output data corresponding to the request's input as illustrated by arrow 240. The request 225 and response 240 can be passed as normal HTTP requests and responses, where the requests and responses include and/or encode the relevant information. The request 225 can define a particular URL, URI, or other location associated with the REST service 235. In some instances, the particular URL can include at least one input parameter for the REST service. In other instances, input parameters can be encoded in the request 225. The response 240 is received by the RCF 215, with the output returned to the business application 210 as illustrated by arrow 245. The business application 210 can process the information internally (as shown by arrow 250), including by formatting the output into a harmonized format of the business application 210. The information can then be presented in the browser or UI 205 as illustrated by arrow 255. In many instances, the incorporation of the REST service's output can be included in a transparent manner into the other output of the business application 210. In other instances, the output of the REST service may be presented, without integrating the output into other functions of the business application 210.

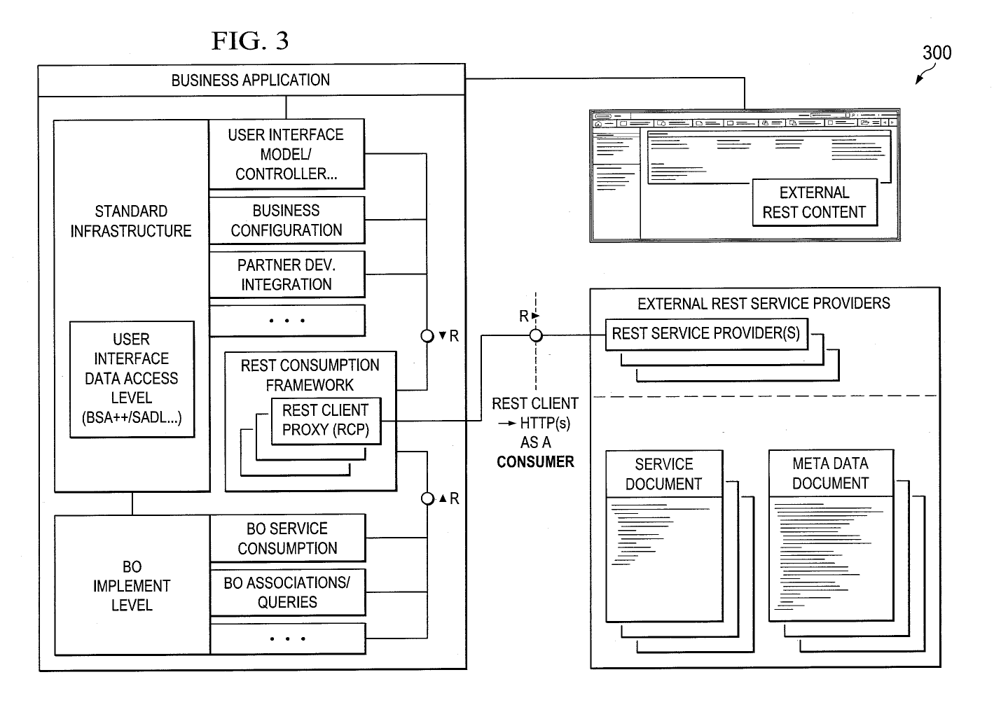

FIG. 3 generally illustrates additional detail associated with the example implementation of FIG. 2. For example, portions of the business application that may generally interact with one or more business objects are illustrated as interacting with the RCF and the one or more RCPs in FIG. 3. For example, the UI model and controller can be integrated with the RCP, as the RCP can be represented as a business object. Information associated with the RCP can then be presented within the browser/UI of the client in a uniform presentation as that of the data and output generated internally to the business application itself Business configuration can be performed with particular RCPs using one or more BCOs (as described in FIG. 1). In some instances, a partner can add REST service-specific integration into the business application using the RCF and RCP corresponding to a particular REST service provided by the partner. For example, a partner who is also associated with a particular REST service can provide additional integration components into the business application and its associated programming, and enhance the set of information received from the execution of the REST service. As each RCP can provide various services normally associated with business objects, an implementation of a particular RCP can be used to consume services associated with the RCP, which may then be performed via a call to the REST provider. Various associations, queries, and other actions generally associated with business objects can also be implemented using a particular RCP.

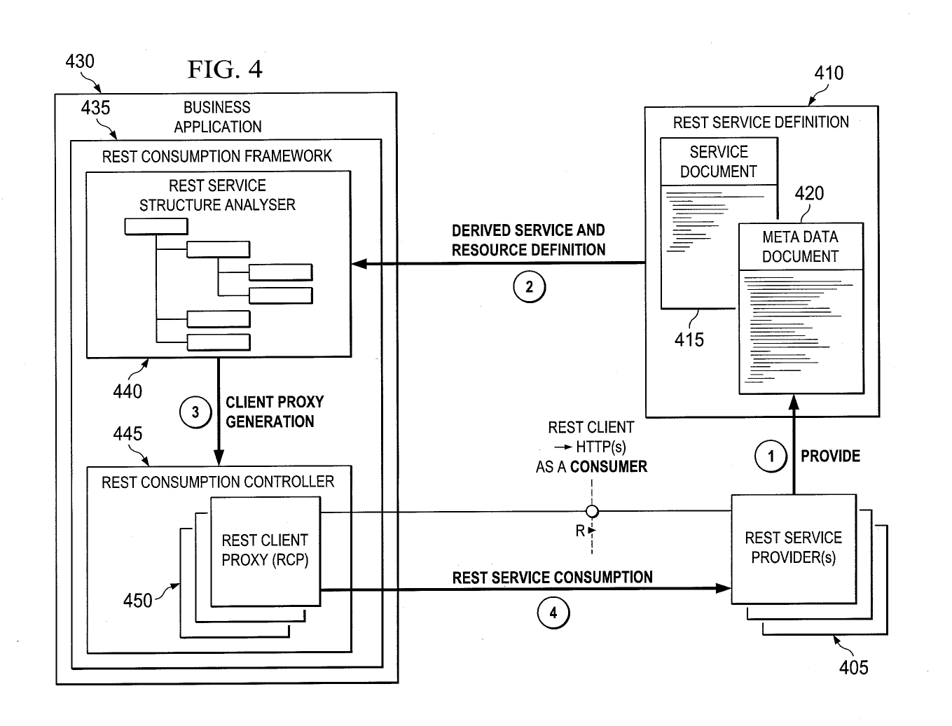

FIG. 4 is an illustration of an example process for analyzing a particular REST service and generating an associated RCP for consuming the particular REST service. Portions of FIG. 4 correspond to elements illustrated in FIG. 1, although FIG. 4 represents but one example implementation.

As illustrated by (1), one or more REST service providers 405 can provide REST service definitions 410 to an associated repository. The repository may be local to a particular REST service provider 405 (i.e., on a server upon which the corresponding REST service is executed), or the repository may be in a cloud-based network or other central or remote location. Systems interested in or searching for information regarding a particular REST service can use various techniques to identify the service definitions corresponding to the particular REST service. The REST service definitions 410 can include one or more service documents 415 and one or more metadata documents 420. The service document 415 can describe how the particular REST service operates, while the metadata document 420 can describe the inputs and outputs associated with and/or required by the particular REST service In some instances or implementations, the REST service definition 410 may be a single document or file, with the information combined, as well as three or more documents, where appropriate.

Business application 430 is associated with an RCF 435 similar to that described in FIG. 1. The RCF 435 is used to assist the business application 430 in identifying, analyzing, and consuming REST services. Specifically, when the business application 430 is determined to need a particular REST service, the RCF 435 access the REST service definition 410 of the corresponding REST service and retrieves the corresponding documentation as illustrated by (2). In the current example, the documentation includes the service document 415 and the metadata document 420. In some instances, determining that a particular REST service is needed by the business application 430 may include a user request to incorporate a particular REST service into existing functionality of the business application 430, an automatic detection by the RCF 435 of a relevant REST service that may be incorporated into the business application's functionality, or any other suitable methods. Using the retrieved or derived information, the REST service structure analyzer 440 of the RCF 435 analyzes how the REST service is called and consumed, including potential configurations of the REST service, the authentication protocols required to access or use the REST service, the input needed by the REST service to perform its functionality, and the set of expected or defined output returned by the REST service, among others. The REST service structure analyzer 440 can parse through the received documentation to determine the appropriate structure and content needed for a REST client proxy (RCP) 450 to be generated.

As illustrated by (3), the REST service structure analyzer 440 can then generate an RCP 450 corresponding to the REST service that will allow the business application 430 to access and consume the REST service at runtime. The RCP 450 can be stored with one or more other RCPs in memory, an RCP repository, or any other suitable location. RCPs 450 can generally be reused by the business application 430 in multiple instances to allow for the REST service to consumed without requiring new creations of proxies. In some instances, the RCP 450 can be a business object compatible with the business application 430, as well as an interface that can be instantiated to interact and consume the REST service. The RCP 450 may be any other suitable object or construct that allows the business application 430 to access and consume a particular REST service associated with the RCP 450. In some instances, generation of the RCP 450 can include generation of additional artifacts and elements associated with the generated entity, including transaction patterns defining how the REST service can be accessed via the RCP 450, system administrative data (e.g., defining access rights and other related information with the generated RCP), personalization capabilities, potential extensibility, analytic functionality, SDK integration, and others. The generated RCP 450 may also include or be associated with one or more authentication proxy artifacts and/or business configuration objects (not illustrated).

As illustrated by (4), the generated RCPs 450 can be used at runtime by the REST consumption controller 445 (interacting with the business application 430) to consume particular REST services. The business application 430 can use the RCF 435 and its REST consumption controller 445 to manage the consumption of the REST service through the corresponding RCP 450. In some instances, multiple instances of a particular RCP 450 can be used to access the corresponding REST service concurrently and/or for different operations and/or data. The RCP 450 can be associated with input information and data from the business application 430 (e.g., passed to the REST consumption controller 445), with the RCP 450 performing or causing the generation of an appropriate request to the REST service provider 405 and its corresponding REST service, with the RCP 450 then receiving and parsing a response or responsive message from the REST service. The output of the REST service can be passed back to the business application 430 and incorporated into the business application's associated processing. This integration of the REST service functionality into the business application 430 can provide for seamless enhancement and additions to the business application, where the REST service's operations are transparent to the end user and easily accessible to developers.

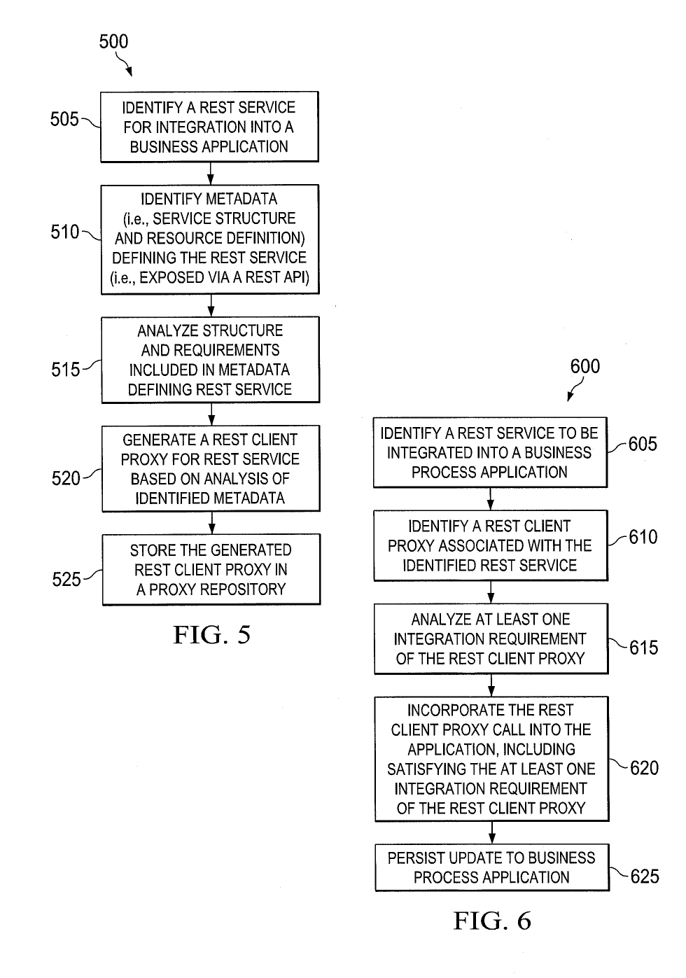

FIG. 5 is a flowchart of an example method 500 for generating a RCP associated with a particular external REST service. For clarity of presentation, the description that follows generally describes method 500 in the context of environment 100 illustrated in FIG. 1. However, it will be understood that method 500 may be performed, for example, by any other suitable system, environment, or combination of systems and environments, as appropriate.

At 505, a REST service is identified for integration into or with a business application. The identification may be performed manually by a developer of the business application. Alternatively, an intelligent detection or discovery process may be performed to identify potential integration for REST services prior to their identification. For instance, one or more network-accessible locations may be identified as “of interest,” such that new REST services associated with those locations are considered identified for integration into or with the business application. One possible location may be a particular UDDI or other web service registry, as well as a predefined individual or set of URLs/URIs. Other suitable methods of identification may be used as appropriate. Although not illustrated, a check may be performed within an RCP directory or repository to determine if the REST service already corresponds to a generated RCP. If so, method 500 may end, as the previously generated RCP may be used to consume the REST service to be integrated.

At 510, metadata defining the identified REST service can be identified. In many cases, the metadata defining the REST service may be made available by the corresponding REST service provider at a location close to or on the same system as the identified REST service. In other instances, the metadata information may be available apart or remote from the REST service. The metadata can include service documents, metadata documents, and other appropriate documentation. In some cases, the documentation may be represented as XML documents, or another suitable file type for being interpreted and parsed by an RCF.

At 515, the structure and requirements of the REST service as defined in the identified metadata is analyzed. In some instances, this analysis may be performed by a design-time component of an RCF associated with the business application. In those instances, the RCF can use its inherent functionality or a specialized component to parse and interpret the information within the identified metadata. For example, the information on the types of inputs required, the expected output of the REST service, the authentication requirements, and the various business configuration options, among others, can be analyzed, and used in the creation of the RCP.

At 520, an RCP for the identified REST service is generated based on the analysis of the identified metadata. Specifically, the RCP can a proxy through which the REST service can be called and consumed by the business application. In some instances, the RCP can be a business object, while in others the RCP can be an interface or other suitable object. The RCP can receive the proper inputs associated with the REST service as inputs, and can provide the output of the REST service to the associated business applications. One or more methods associated with the REST service can be incorporated into the RCP, such as methods for calling the REST service, as well as methods for incorporating the REST service into one or more types of preexisting functionality and operations within the business application. In addition to the RCP, authentication proxy artifacts and business configuration objects can be generated that are associated with the REST service and the generated RCP. The objects can then be used along with future instantiations or uses of the generated RCP to properly authenticate the calling business object, as well as to identify a particular configuration of the REST service to use (where appropriate). The generated RCP can, in some cases, be used in a manner similar to other business objects, where messages and events associated with the business application can be used in connection with the RCPs to perform transparent integration of REST service functionality within the business application.

At 525, the generated RCP is stored in a proxy repository, along with any other associated artifacts and/or objects generated at 520. The associated artifacts/objects can be stored with the generated RCP, or in a separate location with a defined relationship or association to the RCP. Further, the stored RCP and its associated component can generally be used with multiple business applications once the RCP is generated, allowing other developers to consume the REST service without the need to repeat the operations of FIG. 5 again. Additionally, multiple instantiations of the RCP could be used by the same business application to consume the REST service for more than one operation or event.

FIG. 6 is a flowchart of an example method 600 for integrating a particular RCP into a business application. For clarity of presentation, the description that follows generally describes method 600 in the context of environment 100 illustrated in FIG. 1. However, it will be understood that method 600 may be performed, for example, by any other suitable system, environment, or combination of systems and environments, as appropriate.

At 605, a REST service to be integrated into a business application is identified. Generally, the identification for integration will be performed manually by a developer, although in some instances the REST service may be identified automatically using a tool or other searching component that may assist developers in identifying suitable components for performing operations within an application. At 610, an RCP associated with the identified REST service is identified. In some instances, a proxy registry or other persistency or storage location may be searched to find the corresponding RCP. Method 600 is used within an assumption that a previous RCP associated with the identified REST service exists. If an RCP corresponding to the identified REST service does not exist, the operations of FIG. 5 may be used to generate the corresponding RCP.

At 615, at least one integration requirement of the corresponding RCP is analyzed. In some instances, this may include determining the appropriate input needed by the RCP to properly consume the corresponding REST service. In some instances, the integration requirements may also include the determination of an appropriate business configuration object to use based on one or more options associated with the REST service. In some instances, the particular business configuration object to use with the RCP may be based on a runtime determination using predefined logic or a manual selection from the user, among others. In some instances, the integration requirement may also require specific user credentials or other authorization information, thereby allowing a corresponding authentication proxy artifact associated with the RCP to receive the appropriate information needed to access and consume the REST service. At 620, the RCP can optionally be incorporated into the business application. The incorporation may require satisfying the at least one integration requirement of the RCP. In model-based development environments, the appropriate inputs and associated information may be connected to the RCP based on an identified set of integration requirements. At 625, the update to the business application with the integration of the RCP is persisted and made available to the developer and other suitable users and/or developers.

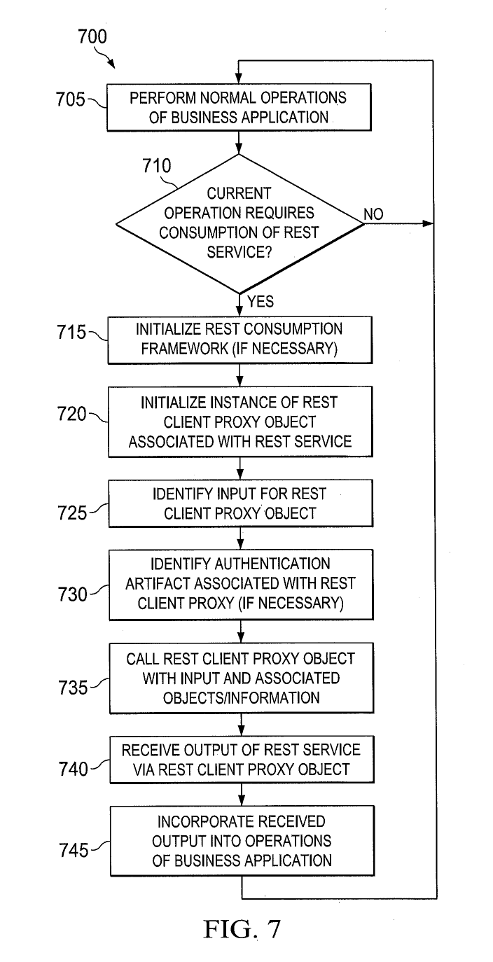

FIG. 7 is a flowchart of an example method 700 for using a particular RCP in a business application to consume the external REST service corresponding to the particular RCP. For clarity of presentation, the description that follows generally describes method 700 in the context of environment 100 illustrated in FIG. 1. However, it will be understood that method 700 may be performed, for example, by any other suitable system, environment, or combination of systems and environments, as appropriate.

At 705, normal operations of a business application are performed. At 710, a determination is made as to whether the current operation of the business application requires the consumption of a REST service through the use of a corresponding RCP. If not, method 700 returns to 705 and the business application's normal operations. If, however, a REST service is to be consumed, method 700 continues at 715.

At 715, the REST consumption framework (RCF) is initialized, if necessary. At 720, an instance of the RCP associated with the REST service to be consumed can be initialized or instantiated, and prepared for use with the business application. At 725, the input to be used with the instantiated RCP is identified based on the integration with the business application and the events, actions, or data associated with the REST service. At 730, the appropriate authentication proxy artifact needed or to be used with the instantiated RCP is identified based on its underlying connection to the RCP. Additionally, a particular business configuration object associated with the instantiated RCP can be identified, allowing for some customization of the REST service call and operations, where appropriate.

At 735, the RCF (and its components, such as its REST consumption controller) can call the instantiated RCP using the identified input, authorization proxy object, business configuration objects, and/or other related information or components to access the corresponding REST service. The use of the RCP can provide an HTTP request across a network to the URL or URI associated with the REST service, with the input and other information used as input to the request. At 740, the REST service can use the input received, process the input based on the REST service's functionality, and return the output of the REST service to the RCP. At 745, the business application can receive the REST service's output via the RCP and incorporate that output into the operations of the business application. Information received from the RCP can be treated in a manner similar to output associated with one or more methods of other instantiated business objects and/or interfaces, with that information being seamlessly incorporated into the operations and presentation of the business application. Once complete, method 700 returns to 705 to continue normal operations of the business application.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer program product for implementing web services, the computer program product comprising computer readable instructions embodied on tangible, non-transitory media, the instructions operable when executed to:
identify a REST service for integration with a business application;
identify a set of metadata associated with the REST service; and
generate a REST client proxy object associated with the REST service for use in consuming the REST service with the business application, where an instantiation of the REST client proxy object is consumable via the business application.

2. The product of claim 1, the operations further operable when executed to consume the REST service using an instantiation of the generated REST client proxy object associated with the REST service.

3. The product of claim 1, wherein the REST service is available at a web-accessible location (URL).

4. The product of claim 1, wherein the identified set of metadata associated with the REST service includes a service structure document and a metadata document.

5. The product of claim 2, wherein generating the REST client proxy object includes generating at least one business configuration object associated with the REST client proxy object, each business configuration object defining at least one option for consuming the REST service.

6. The product of claim 5, wherein consuming the REST service using the instantiation of the generated REST client proxy object associated with the REST service includes selecting a particular business configuration object to consume the REST service with the at least one defined option associated with the particular business configuration object selected.

7. The product of claim 5, wherein each business configuration object identifies a particular URL associated with the at least one option for consuming the REST service.

8. The product of claim 2, wherein generating the REST client proxy object includes generating at least one authentication proxy artifact associated with the REST service, each authentication proxy artifact defining at least one authentication method accepted by the REST service.

9. The product of claim 8, wherein consuming the REST service using the instantiation of the generated REST client proxy object associated with the REST service includes using a particular authentication proxy artifact by the REST client proxy object to satisfy at least one authentication requirement associated with the REST service.

10. The product of claim 2, wherein consuming the REST service using the instantiation of the generated REST client proxy object associated with the REST service includes:
receiving input from the business application associated with the REST client proxy object; and
calling the REST service using the REST client proxy object and the received input.

11. The product of claim 1, the instructions operable when executed to:
receive a set of output data from the REST service via the REST client proxy object; and
integrating the received set of output data into operations of the business application.

12. A computer-implemented method for implementing web services, the method comprising:
identifying a REST service for integration with a business application;
identifying a set of metadata associated with the REST service; and
generating a REST client proxy object associated with the REST service for use in consuming the REST service with the business application, where an instantiation of the REST client proxy object is consumable via the business application.

13. The method of claim 12, the method further comprising to consuming the REST service using an instantiation of the generated REST client proxy object associated with the REST service.

14. The method of claim 12, wherein the identified set of metadata associated with the REST service includes a service structure document and a metadata document.

15. The method of claim 13, wherein generating the REST client proxy object includes generating at least one business configuration object associated with the REST client proxy object, each business configuration object defining at least one option for consuming the REST service.

16. The method of claim 15, wherein consuming the REST service using the instantiation of the generated REST client proxy object associated with the REST service includes selecting a particular business configuration object to consume the REST service with the at least one defined option associated with the particular business configuration object selected.

17. The method of claim 15, wherein each business configuration object identifies a particular URL associated with the at least one option for consuming the REST service.

18. The method of claim 13, wherein generating the REST client proxy object includes generating at least one authentication proxy artifact associated with the REST service, each authentication proxy artifact defining at least one authentication method accepted by the REST service.

19. The method of claim 18, wherein consuming the REST service using the instantiation of the generated REST client proxy object associated with the REST service includes using a particular authentication proxy artifact by the REST client proxy object to satisfy at least one authentication requirement associated with the REST service.

20. The method of claim 13, wherein consuming the REST service using the instantiation of the generated REST client proxy object associated with the REST service includes:
receiving input from the business application associated with the REST client proxy object; and
calling the REST service using the REST client proxy object and the received input.

21. A system comprising:
one or more computers; and
a computer-readable medium coupled to the one or more computers having instructions stored thereon which, when executed by the one or more computers, cause the one or more computers to perform operations comprising:
identifying a REST service for integration with a business application;
identifying a set of metadata associated with the REST service; and
generating a REST client proxy object associated with the REST service for use in consuming the REST service with the business application, where an instantiation of the REST client proxy object is consumable via the business application.
